(19) United States
(12) Patent Application Publication
(10) Pub. No.: US 2026/0212869 A1
(43) Pub. Date: Jul. 23, 2026

(54) ELECTRONIC DEVICE AND METHOD TO EMBED PACKET LOSS INFORMATION INTO A PULSE-CODE MODULATION (PCM) SIGNAL

(71) Applicant: MEDIATEK INC., Hsinchu City (TW)

(72) Inventors: Shao-Wei FANJIANG, Hsinchu City (TW); Chao-Ling HSU, Hsinchu City (TW); Yiou-Wen CHENG, Hsinchu City (TW); Xin-Wei SHIH, Hsinchu City (TW); Wei-Han LIU, Hsinchu City (TW)

(21) Appl. No.: 19/452,541

(22) Filed: Jan. 19, 2026

Related U.S. Application Data
(60) Provisional application No. 63/747,111, filed on Jan. 20, 2025.

(51) Int. Cl. G10L 19/005

(52) U.S. Cl. CPC G10L 19/005

(57) ABSTRACT

An electronic device includes a memory and an application processor. The a memory includes a plurality of addresses. The processor is electrically connected to the memory. The processor receives a plurality of audio packets. The processor determines, for each of the plurality of audio packets, whether the respective audio packet has packet loss. In response to determining that a first audio packet does not have packet loss, the processor stores the first audio packet into a first address. In response to determining that a second audio packet has packet loss, the processor stores a packet loss indicator into a second address. The application processor performs a first-stage packet loss concealment (PLC) on the second audio packet in response to the packet loss indicator.

### CROSS REFERENCE TO RELATED APPLICATIONS

This application claims the benefit of U.S. provisional application No. 63/747,111, filed on January, 20, 2025, the entirety of which is incorporated by reference herein.

### BACKGROUND OF THE INVENTION

### Field of the Invention

The present invention relates to an electronic device, and, in particular, it relates to an electronic device and a method to embed packet loss information into a pulse-code modulation (PCM) signal.

### Description of the Related Art

Packet loss concealment (PLC) is often used to handle packet loss in audio transmissions, such as Voice over Internet Protocol (VoIP), True Wireless Stereo (TWS), wireless speakers, etc.

PLC is often included in various codecs (though some codecs do not have PLC). This bundling leads to some issues. First, since codecs are usually designed with specific resource requirements in mind, they can only use simpler PLC methods, which can reach their limits in more severe interference environments, affecting user experience.

Second, the native PLC algorithms of codecs often require internal information from the codec, making them unusable in other contexts. Third, if the user wants to extend the native PLC or add PLC in an environment without a PLC framework, the release of packet information is unavoidable (e.g., when packet loss occurs, how much signal to output at once).

### BRIEF SUMMARY OF THE INVENTION

An embodiment of the present invention provides an electronic device. The electronic device includes a memory and an application processor. The memory includes a plurality of addresses. The processor is electrically connected to the memory. The processor receives a plurality of addresses. The processor determines, for each of the plurality of audio packets, whether the respective audio packet has packet loss. In response to determining that a first audio packet of the plurality of audio packets does not have packet loss, the processor stores the first audio packet into the first address. In response to determining that a second audio packet of the plurality of audio packets has packet loss, the processor stores a packet loss indicator into the second address. The application processor performs a first-stage packet loss concealment (PLC) on the second audio packet in response to the packet loss indicator.

According to the electronic device described above, the application processor does not store the second audio packet with the packet loss into the second address of the memory.

According to the electronic device described above, the application processor performs a codec function to decode a modulation audio signal into a pulse-code modulation (PCM) signal. The PCM signal includes the first audio packet and the second audio packet.

According to the electronic device described above, the application processor performs a second-stage PLC for the second audio packet in response to the packet loss indicator.

The electronic device further includes a digital signal processor. The digital signal processor is electrically connected to the application processor. The digital signal processor receives the PCM signal from the application processor, and performs a second-stage PLC for the second audio packet in response to the packet loss indicator.

According to the electronic device described above, the application processor stores the current scene of the PCM signal into the second address. The current scene of the PCM signal includes speech, music, or pure noise.

According to the electronic device described above, the current scene of the PCM signal is stored adjacent to the packet loss indicator in the second address.

According to the electronic device described above, the application processor converts an audio analog signal into a pulse-code modulation (PCM) signal. The PCM signal includes the first audio packet and the second audio packet.

The electronic device further includes a digital signal processor. The digital signal processor is electrically connected to the application processor. The digital signal processor receives the PCM signal from the application processor, and performs a second-stage PLC for the second audio packet in response to the packet loss indicator.

According to the electronic device described above, the packet loss indicator includes a string.

An embodiment of the present invention also provides a method to embed packet loss information into a pulse-code modulation (PCM) signal. The method includes the following steps. A plurality of audio packets are received. It is determined for each of the plurality of audio packets whether the respective audio packet has packet loss. In response to determining that a first audio packet of the plurality of audio packets does not have packet loss, the first audio packet is stored into a first address of the plurality of addresses. In response to determining that a second audio packet of the plurality of audio packets has packet loss, a packet loss indicator is stored into a second address of the plurality of addresses. A first-stage packet loss concealment (PLC) is performed for the second audio packet in response to the packet loss indicator.

The method further includes the following step. The second audio packet with the packet loss is not stored into the second address.

The method further includes the following step. A codec is performed to decode a modulation audio signal into the PCM signal.

The method further includes the following step. A second-stage PLC is performed for the second audio packet in response to the packet loss indicator.

The method further includes the following step. The current scene of the PCM signal is stored into the second address. The current scene of the PCM signal includes speech, music, or pure noise.

According to the method described above, the current scene of the PCM signal is stored adjacent to the packet loss indicator in the second address.

According to the method described above, the packet loss indicator includes a predefined data value.

### BRIEF DESCRIPTION OF THE DRAWINGS

The present invention can be more fully understood by reading the subsequent detailed description and examples with references made to the accompanying drawings.

FIG. 1 is a schematic diagram of an electronic device 100 in accordance with some embodiments of the present invention.

FIG. 2 is a schematic diagram of a pulse-code modulation (PCM) signal 120 and a memory 104 in FIG. 1 in accordance with some embodiments of the present invention.

FIG. 3 is a schematic diagram of an audio system including the electronic device 100 in FIG. 1 in accordance with some embodiments of the present invention.

FIG. 4 is a schematic diagram of an audio system including the electronic device 100 in FIG. 1 in accordance with some embodiments of the present invention.

FIG. 5 is a schematic diagram of an audio system including the electronic device 100 in FIG. 1 in accordance with some embodiments of the present invention.

FIG. 6 is a schematic diagram of an audio system including the electronic device 100 in FIG. 1 in accordance with some embodiments of the present invention.

FIG. 7 is a flow chart of a method to embed packet loss information into a pulse-code modulation (PCM) signal in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to...”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

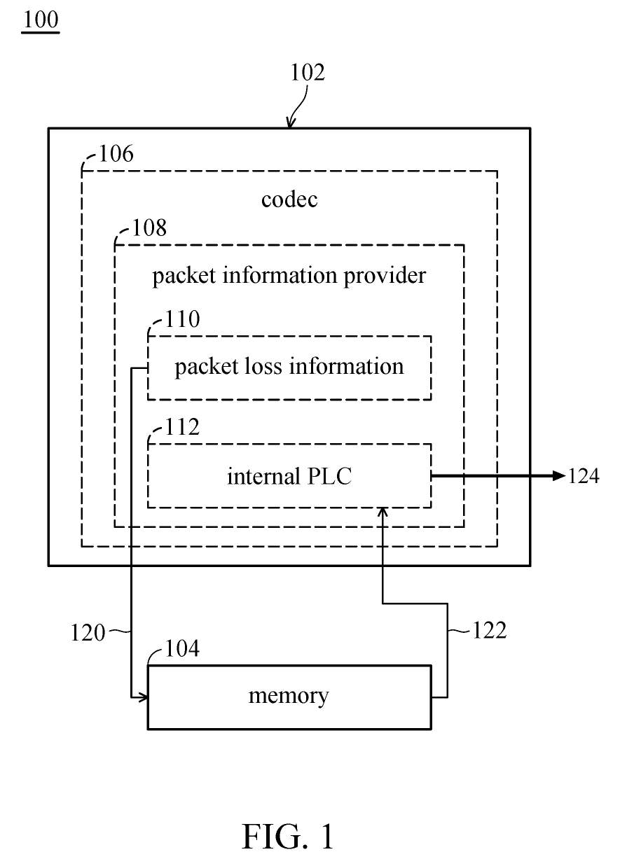

FIG. 1 is a schematic diagram of an electronic device 100 in accordance with some embodiments of the present invention. As shown in FIG. 1, the electronic device 100 includes an application processor 102 and a memory 104. The application processor 102 performs a codec 106 to decode a modulation audio signal into a pulse-code modulation (PCM) signal. The application processor 102 performs the codec 106 to generate a packet information provider 108. In some embodiments of FIG. 1, an internal packet loss concealment (PLC) 112 is included in the packet information provider 108 or the codec 106. In some embodiments of FIG. 1, the memory 104 has a plurality of addresses.

The application processor 102 is electrically connected to the memory 104. The application processor 102 receives a plurality of audio packets. The application processor 102 determines, for each of the plurality of audio packets, whether the respective audio packet has packet loss. In response to determining that a first audio packet of the plurality of audio packets does not have packet loss, the application processor 102 stores the first audio packet into the first address. In response to determining that a second audio packet of the plurality of audio packets has packet loss, the application processor 102 stores a packet loss indicator (such as packet loss information 110) into the second address. The application processor 102 does not store the second audio packet with the packet loss into the second address of the memory 104. The PCM signal 120 includes the first audio packet and the second audio packet.

The application processor 102 performs the internal PLC 112 for the second audio packet in response to the packet loss indicator. For example, the application processor 102 reads the first address and the second address in the memory 104 to obtain the PCM signal 122, and performs internal PLC 112 for the second audio packet in the PCM signal 122 in response to the packet loss indicator to obtain the PCM signal 124. After that, the application processor 102 sends out the PCM signal 124 to other audio devices. In some embodiments, the memory 104 may be included in the application processor 102, but the present invention is not limited thereto.

The packet loss indicator, which is stored in the memory (e.g., the memory) in place of a lost or corrupted audio packet, serves as a signal for a downstream component to initiate a packet loss concealment (PLC) procedure. In a general aspect, the packet loss indicator comprises a predefined data value. This predefined data value is specifically chosen to be unambiguously distinguishable from valid audio packet data. A component, such as the application processor or a digital signal processor, is configured to recognize this predefined data value and, in response, trigger the appropriate PLC algorithm instead of attempting to process it as audio data. The following descriptions provide several non-limiting examples of how such a predefined data value can be implemented.

1. Implementation as a String: In some embodiments, the predefined data value may be a character string. For example, the application processor may store an ASCII or Unicode string such as “LOSSY-SIN”, “Do Conceal”, "PKT_LOSS", "PLC_REQ", or "ERR" into the memory address reserved for the lost packet. This human-readable format can be advantageous for system debugging and monitoring, as the state of the audio buffer can be easily inspected.

2. Implementation as an Integer: In other embodiments, the predefined data value is a specific integer. For instance, in a system using 16-bit signed Pulse-Code Modulation (PCM) audio samples (ranging from -32768 to 32767), a value outside of this range or a reserved value within it, such as -1 or 0x8000, could be used as the indicator. The processing unit can perform a simple and computationally efficient integer comparison to detect this value.

3. Implementation as a Flag Bit: In yet another embodiment, the packet loss indicator is implemented as a flag bit within a larger data word. The data stored at the memory address may be a composite data structure where a specific bit, for example, the most significant bit (MSB), is designated as the packet loss flag. If this bit is set to '1', it indicates packet loss, while a '0' indicates a valid packet. The remaining bits in the data word could be zeroed out or used to store other relevant information, such as the current scene information (e.g., speech, music). This approach is highly efficient in terms of memory usage.

4. Implementation as a Null Pointer: In embodiments where the memory stores pointers to audio data buffers rather than the audio data itself, the packet loss indicator can be a null pointer (e.g., NULL or 0x0). When a downstream process attempts to access the data for the audio packet, it receives a null pointer. This signals that the data is absent and that a concealment procedure should be initiated instead of dereferencing the pointer, thus preventing a system fault.

5. Implementation as a Not-a-Number (NaN) Value: In embodiments where audio samples are processed using a floating-point representation, a special floating-point value, Not-a-Number (NaN), can be used as the packet loss indicator. Standard floating-point hardware units are designed to handle and detect NaN values. Storing a NaN value in the memory address provides a robust and hardware-accelerated mechanism for the processor to identify locations requiring PLC during arithmetic operations.

In some embodiments of FIG. 1, the application processor 102 determines that both the first audio packet and the second audio packet do not have the packet loss. Therefore, the application processor 102 stores the first audio packet into the first address, and stores the second audio packet into the second address. The internal PLC 112 may not be performed in response to the first audio packet and the second audio packet not having the packet loss.

In some embodiments of FIG. 1, the application processor 102 stores the current scene of the PCM signal 120 into the second address. The current scene of the PCM signal 120 includes speech, music, or pure noise, but the present invention is not limited thereto. In some embodiments, the current scene of the PCM signal 120 is stored adjacent to the packet loss indicator in the second address.

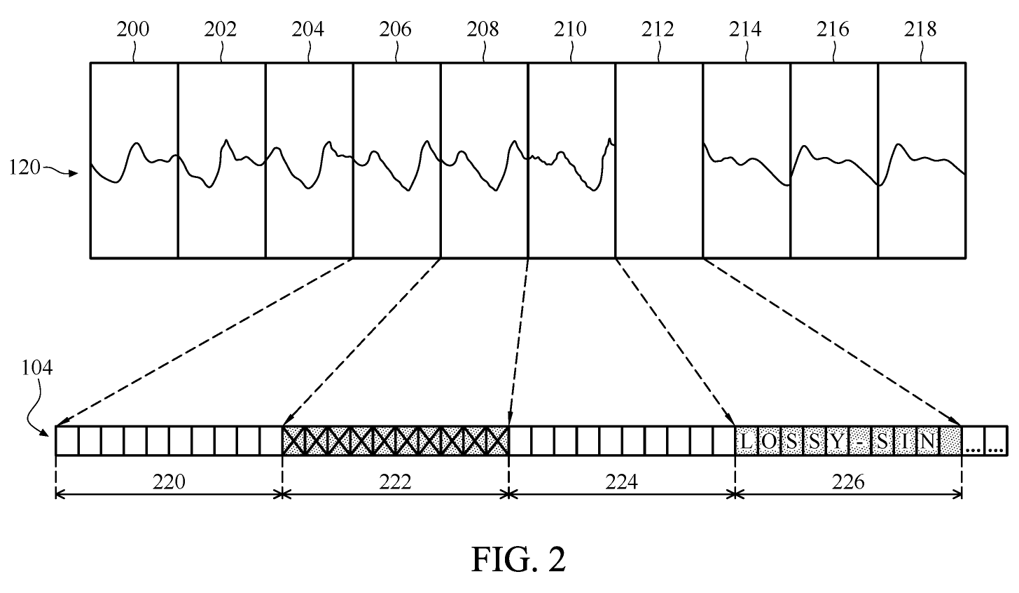

FIG. 2 is a schematic diagram of a pulse-code modulation (PCM) signal 120 and a memory 104 in FIG. 1 in accordance with some embodiments of the present invention. As shown in FIG. 2, the PCM signal 120 includes an audio packet 200, an audio packet 202, an audio packet 204, an audio packet 206, an audio packet 208, an audio packet 210, an audio packet 212, an audio packet 214, an audio packet 216, and an audio packet 218. The application processor 102 determines that the audio packet 200, the audio packet 202, the audio packet 204, the audio packet 206, the audio packet 210, the audio packet 214, the audio packet 216, and the audio packet 218 do not have packet loss. The application processor 102 determines that the audio packet 208 originally has packet loss and the audio packet 212 currently has packet loss.

The memory 104 includes an address 220, an address 222, an address 224, and an address 226. Since the application processor 102 determines that the audio packet 206 and the audio packet 210 do not have packet loss, the application processor 102 stores the audio packet 206 into the address 220, and stores the audio packet 210 into the address 224. Since the application processor 102 determines that the audio packet 208originally has packet loss, the application processor 102 stores a packet loss indicator into the address 222. The application processor 102 performs packet loss concealment (PLC) for the audio packet 208 in response to the packet loss indicator, so that the audio packet 208 is compensated, and stores the compensated audio packet 208 into the address 222. Since the application processor 102 determines that the audio packet 212 currently has packet loss, the application processor 102 stores a packet loss indicator into the address 226.

In some embodiments, the application processor 102 first determines that the audio packet 212 do not have any contents during a timer is counting. After the timer is expired, the application processor 102 thus determines that the audio packet 212 have packet loss. In some embodiments, packet loss indicator may include a string, for example, “LOSSY-SIN”, but the present invention is not limited thereto. The packet loss indicator may also include integer, flag bit, null pointer, and NaN, but the present invention is not limited thereto.

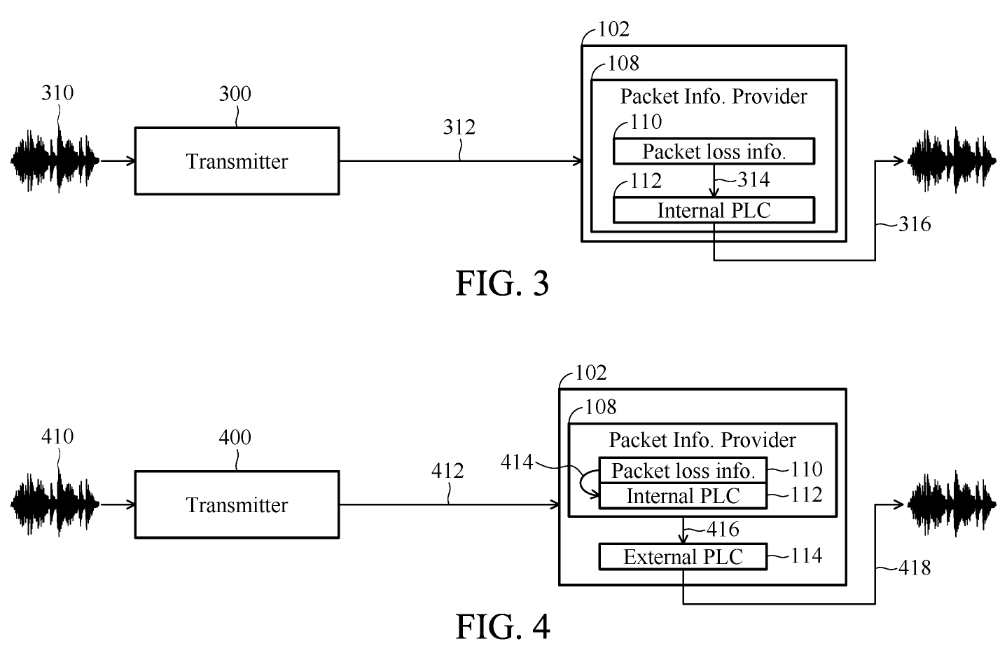

FIG. 3 is a schematic diagram of an audio system including the electronic device 100 in FIG. 1 in accordance with some embodiments of the present invention. As shown in FIG. 3, the audio system in FIG. 3 includes a transmitter 300 and the electronic device 100 in FIG. 1. The transmitter 300 receives an audio signal 310, and converts the audio signal 310 into a modulation audio signal 312 by using an encoder of a codec. The application processor 102 of the electronic device 100 receives the modulation audio signal 312. The application processor 102 performs the codec 106 to convert the modulation audio signal 312 into a PCM signal by a decoder of the codec 106. The PCM signal includes a first audio packet and a second audio packet. The packet information provider 108 executed in the application processor 102 determines that the first audio packet does not have packet loss and the second audio packet has packet loss. The packet information provider 108 executed in the application processor 102 embeds the packet loss information 110 into the PCM signal to output a PCM signal 314.

In some embodiments of FIG. 3, the memory 104 reserves a first address for storing the first audio packet and a second address for storing the second audio packet. The packet information provider 108 embeds the packet loss information 110 into the PCM signal by storing the first audio packet into the first address and storing a packet loss indicator into the second address. The application processor 102 performs the internal PLC 112 for the second audio packet in response to the packet loss indicator to generate a PCM signal 316. The application processor 102 then sends out the PCM signal 316 to other audio devices. The audio system in FIG. 3 can avoid generating additional path in hardware or software to transmit the information required for PLC operation. This effectively reduces the cost required for integration.

FIG. 4 is a schematic diagram of an audio system including the electronic device 100 in FIG. 1 in accordance with some embodiments of the present invention. As shown in FIG. 4, the audio system in FIG. 4 includes a transmitter 400 and the electronic device 100 in FIG. 1. The transmitter 400 receives an audio signal 410, and converts the audio signal 410 into a modulation audio signal 412 by using an encoder of a codec. The application processor 102 of the electronic device 100 receives the modulation audio signal 412. The application processor 102 performs the codec 106 to convert the modulation audio signal 412 into a PCM signal by a decoder of the codec 106. The PCM signal includes a first audio packet and a second audio packet. The packet information provider 108 executed in the application processor 102 determines that the first audio packet does not have packet loss and the second audio packet has packet loss. The packet information provider 108 executed in the application processor 102 embeds the packet loss information 110 into the PCM signal to output a PCM signal 414.

In some embodiments of FIG. 4, the memory 104 reserves a first address for storing the first audio packet and a second address for storing the second audio packet. The packet information provider 108 embeds the packet loss information 110 into the PCM signal to generate the PCM signal 414 by storing the first audio packet into the first address and storing a packet loss indicator into the second address. The application processor 102 performs the internal PLC 112 for the second audio packet in response to the packet loss indicator to generate a PCM signal 416. The application processor 102 further performs an external PLC 114 for the second audio packet in response to the packet loss indicator to generate a PCM signal 416. The application processor 102 then sends out the PCM signal 416 to other audio devices. The external PLC 114 can integrate easily without the need for additional paths. In some embodiments of FIG. 4, the packet loss indicator may include a string, for example, “Do Conceal”, but the present invention is not limited thereto.

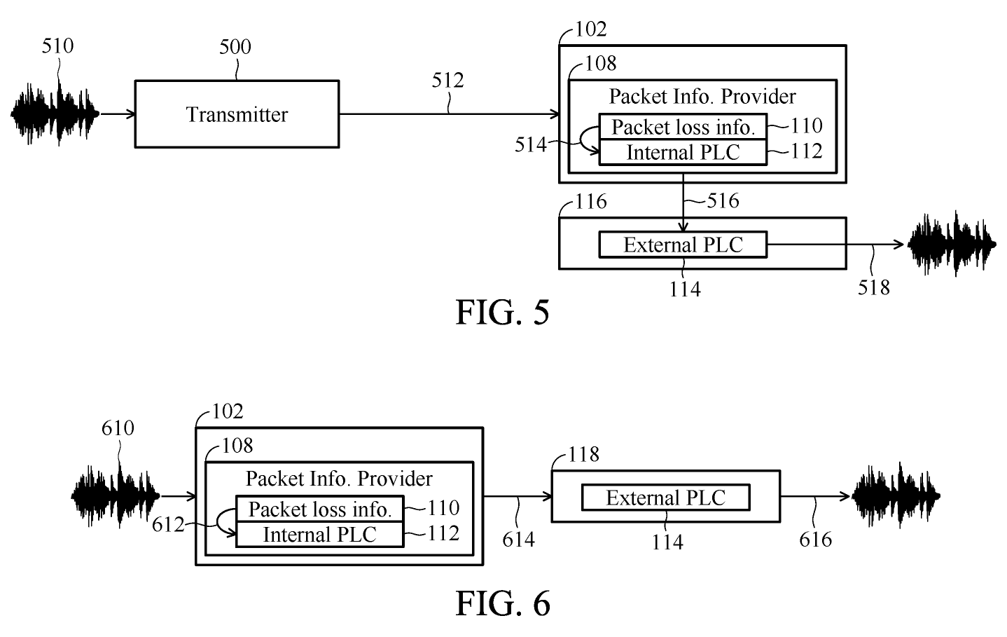

FIG. 5 is a schematic diagram of an audio system including the electronic device 100 in FIG. 1 in accordance with some embodiments of the present invention. As shown in FIG. 5, the audio system in FIG. 5 includes a transmitter 500 and the electronic device 100 in FIG. 1. The transmitter 500 receives an audio signal 510, and converts the audio signal 510 into a modulation audio signal 512 by using an encoder of a codec. The application processor 102 of the electronic device 100 receives the modulation audio signal 512. The application processor 102 performs the codec 106 to convert the modulation audio signal 512 into a PCM signal by a decoder of the codec 106. The PCM signal includes a first audio packet and a second audio packet. The packet information provider 108 executed in the application processor 102 determines that the first audio packet does not have packet loss and the second audio packet has packet loss. The packet information provider 108 executed in the application processor 102 embeds the packet loss information 110 into the PCM signal to output a PCM signal 514.

In some embodiments of FIG. 5, the memory 104 reserves a first address for storing the first audio packet and a second address for storing the second audio packet. The packet information provider 108 embeds the packet loss information 110 into the PCM signal to generate the PCM signal 514 by storing the first audio packet into the first address and storing a packet loss indicator into the second address. The application processor 102 performs the internal PLC 112 for the second audio packet in response to the packet loss indicator to generate a PCM signal 516. In some embodiments of FIG. 5, the electronic device 100 further includes a digital signal processor 116. The digital signal processor 116 is electrically connected to the application processor 102. The digital signal processor 116 receive the PCM signal 516 from the application processor 102, and performs an external PLC 114 for the second audio packet in response to the packet loss indicator to generate a PCM signal 518. The application processor 102 then sends out the PCM signal 518 to other audio devices.

Since the external PLC 114 is executed by the digital signal processor 116 and the internal PLC 112 is executed by the application processor 102, the external PLC 114 can access greater computational resources, allowing it to perform more complex calculations and achieve better performance.

FIG. 6 is a schematic diagram of an audio system including the electronic device 100 in FIG. 1 in accordance with some embodiments of the present invention. As shown in FIG. 6, the audio system in FIG. 5 includes the electronic device 100 in FIG. 1. The application processor 102 of the electronic device 100 directly receives an audio signal 610. The application processor 102 performs the codec 106 to convert the audio signal 610 into a PCM signal. The PCM signal includes a first audio packet and a second audio packet. The packet information provider 108 executed in the application processor 102 determines that the first audio packet does not have packet loss and the second audio packet has packet loss. The packet information provider 108 executed in the application processor 102 embeds the packet loss information 110 into the PCM signal to output a PCM signal 612.

In some embodiments of FIG. 6, the memory 104 reserves a first address for storing the first audio packet and a second address for storing the second audio packet. The packet information provider 108 embeds the packet loss information 110 into the PCM signal to generate the PCM signal 612 by storing the first audio packet into the first address and storing a packet loss indicator into the second address. The application processor 102 performs the internal PLC 112 for the second audio packet in response to the packet loss indicator to generate a PCM signal 614. In some embodiments of FIG. 6, the electronic device 100 further includes a digital signal processor 118. The digital signal processor 118 is electrically connected to the application processor 102. The digital signal processor 116 receive the PCM signal 614 from the application processor 102, and performs an external PLC 114 for the second audio packet in response to the packet loss indicator to generate a PCM signal 616. The application processor 102 then sends out the PCM signal 616 to other audio devices.

The audio system in FIG. 6 has simpler architectures. For example, a player that simply transmits audio to the electronic device 100. If the application processor 102 is busy, it may not be able to output the PCM signal 614 in time, leading to audio discontinuities. A distributed PLC architecture is introduced in FIG. 6, which can not only provide a concealment effect for packet loss, but also reduce the computational load for the application processor 102.

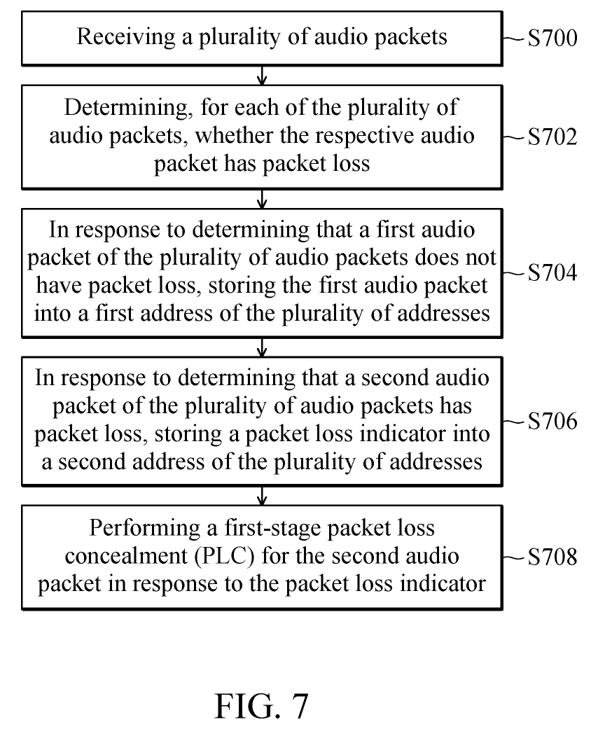

FIG. 7 is a flow chart of a method to embed packet loss information into a pulse-code modulation (PCM) signal in accordance with some embodiments of the present invention. The method includes the following steps. The PCM signal is received. The PCM signal includes a first audio packet and a second audio packet (step S700). It is determined that the first audio packet does not have packet loss and the second audio packet has packet loss (step S702). The first audio packet is stored into a first address reserved for the first audio packet (step S704). A packet loss indicator is stored into a second address reserved for the second audio packet (step S706). A first-stage packet loss concealment (PLC) is performed for the second audio packet in response to the packet loss indicator (step S708).

In some embodiments, the method of the present invention performs a codec function to decode a modulation audio signal into the PCM signal before step S700 is performed. In some embodiments, the method of present invention does not store the second audio packet with the packet loss into the second address in step S706. In some embodiments, the method of the present invention further performs a second-stage PLC for the second audio packet in response to the packet loss indicator.

In some embodiments, the method of the present invention further stores the current scene of the PCM signal into the second address. The current scene of the PCM signal includes speech, music, or pure noise, but the present invention is not limited thereto. In some embodiments, the current scene of the PCM signal is stored adjacent to the packet loss indicator in the second address. In some embodiments, the packet loss indicator in step S706 includes a predetermined data value. The predetermined data value includes string, integer, flag bit, null pointer, and NaN, but the present invention is not limited thereto.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a memory, comprising a plurality of addresses, and
an application processor, electrically connected to the memory, configured to: receive a plurality of audio packets; determine, for each of the plurality of audio packets, whether the respective audio packet has packet loss; in response to determining that a first audio packet of the plurality of audio packets does not have packet loss, store the first audio packet into a first address of the plurality of addresses; in response to determining that a second audio packet of the plurality of audio packets has packet loss, store a packet loss indicator into a second address of the plurality of addresses;
wherein the application processor performs a first-stage packet loss concealment (PLC) for the second audio packet in response to the packet loss indicator.

2. The electronic device as claimed in claim 1, wherein the application processor is not configured to store the second audio packet with the packet loss into the second address of the memory.

3. The electronic device as claimed in claim 1, wherein the application processor is configured to perform a codec function to decode a modulation audio signal into a pulse-code modulation (PCM) signal; wherein the PCM signal comprises the first audio packet and the second audio packet.

4. The electronic device as claimed in claim 3, wherein the application processor is configured to perform a second-stage PLC for the second audio packet in response to the packet loss indicator.

5. The electronic device as claimed in claim 3, further comprising:
a digital signal processor, electrically connected to the application processor, configured to receive the PCM signal from the application processor and perform a second-stage PLC for the second audio packet in response to the packet loss indicator.

6. The electronic device as claimed in claim 3, wherein the application processor is configured to store a current scene of the PCM signal into the second address; wherein the current scene of the PCM signal comprises speech, music, or pure noise.

7. The electronic device as claimed in claim 6, wherein the current scene of the PCM signal is stored adjacent to the packet loss indicator in the second address.

8. The electronic device as claimed in claim 1, wherein the application processor is configured to convert an audio analog signal into a pulse-code modulation (PCM) signal; wherein the PCM signal comprises the first audio packet and the second audio packet.

9. The electronic device as claimed in claim 8, further comprising:
a digital signal processor, electrically connected to the application processor, configured to receive the PCM signal from the application processor and perform a second-stage PLC for the second audio packet in response to the packet loss indicator.

10. The electronic device as claimed in claim 1, wherein the packet loss indicator comprises a predefined data value.

11. A method to embed packet loss information into a pulse-code modulation (PCM) signal, comprising:
receiving a plurality of audio packets;
determining, for each of the plurality of audio packets, whether the respective audio packet has packet loss;
in response to determining that a first audio packet of the plurality of audio packets does not have packet loss, storing the first audio packet into a first address of a plurality of addresses;
in response to determining that a second audio packet of the plurality of audio packets have packet loss, storing a packet loss indicator into a second address of the plurality of addresses, and
performing a first-stage packet loss concealment (PLC) on the second audio packet in response to the packet loss indicator.

12. The method as claimed in claim 11, further comprising:
not storing the second audio packet with the packet loss into the second address.

13. The method as claimed in claim 11, further comprising:
performing a codec function to decode a modulation audio signal into the PCM signal.

14. The method as claimed in claim 11, further comprising:
performing a second-stage PLC for the second audio packet in response to the packet loss indicator.

15. The method as claimed in claim 11, further comprising:
storing a current scene of the PCM signal into the second address, wherein the current scene of the PCM signal comprises speech, music, or pure noise.

16. The method as claimed in claim 15, wherein the current scene of the PCM signal is stored adjacent to the packet loss indicator in the second address.

17. The method as claimed in claim 11, wherein the packet loss indicator comprises a predefined data value.
